(19) United States
(12) Patent Application Publication
(10) Pub. No.: US 2022/0301010 A1
(43) Pub. Date: Sep. 22, 2022

(54) PROXIMITY-BASED AUDIO CONTENT GENERATION

(71) Applicant: Capital One Services, LLC, McLean, VA (US)

(72) Inventors: Chih-Hsiang CHOW, Coppell, TX (US); Elizabeth FURLAN, Plano, TX (US); Steven DANG, Plano, TX (US)

(21) Appl. No.: 17/206,636

(22) Filed: Mar. 19, 2021

(51) Int. Cl. G06Q 30/02

(52) U.S. Cl. CPC G06Q 30/0266; G06Q 30/0267; G06Q 30/0269; G06Q 30/0261

(57) ABSTRACT

In some implementations, a system may receive an indication that a user device is near a proximate vehicle. The system may obtain a user profile associated with the user device that indicates a vehicle attribute category as being of interest to a user. The system may obtain first audio content based on the proximate vehicle and the vehicle attribute category that describes a proximate vehicle attribute corresponding to the vehicle attribute category. The system may identify, based on the vehicle attribute category, a target vehicle located near the proximate vehicle that compares more favorably to a user preference compared to the proximate vehicle. The system may obtain second audio content based on the target vehicle and the user preference that describes a comparison between the proximate vehicle attribute and a target vehicle attribute of the target vehicle. The system may output the first audio content and the second audio content.

### BACKGROUND

Audio content generation is the conversion or generation of information to any audio-based media for an end-user or audience in specific contexts. An audio system may use a speech synthesis system or text-to-speech system that converts normal language text into speech. In some cases, audio content can be created by concatenating pieces of recorded speech that are stored in a database.

### SUMMARY

In some implementations, a system for generating audio content includes one or more memories and one or more processors, communicatively coupled to the one or more memories, configured to: receive an indication that a user device is within a threshold proximity of a first vehicle; obtain a user profile, associated with the user device and to be used to generate the audio content, based on receiving the indication that the user device is within the threshold proximity of the first vehicle, wherein the user profile indicates: a second vehicle associated with a user of the user device, and one or more vehicle attribute categories indicated in the user profile as being of interest to the user; identify or generate first audio content based on the first vehicle and the one or more vehicle attribute categories, wherein the first audio content describes one or more first attributes of the first vehicle corresponding to the one or more vehicle attribute categories; generate second audio content based on the second vehicle and the one or more vehicle attribute categories, wherein the second audio content describes a comparison between the one or more first attributes of the first vehicle and one or more second attributes of the second vehicle corresponding to the one or more vehicle attribute categories; and output the first audio content and the second audio content.

In some implementations, a method for generating audio content includes receiving, by a system, an indication that a user device is within communicative proximity of a proximate vehicle; obtaining, by the system, a user profile associated with the user device based on receiving the indication that the user device is within communicative proximity of the proximate vehicle, wherein the user profile indicates a vehicle attribute category indicated in the user profile as being of interest to a user of the user device; obtaining, by the system, first audio content based on the proximate vehicle and the vehicle attribute category, wherein the first audio content describes a proximate vehicle attribute, of the proximate vehicle, corresponding to the vehicle attribute category; identifying, by the system and based on the vehicle attribute category, a target vehicle located near the proximate vehicle, wherein the target vehicle compares more favorably to a user preference, associated with the vehicle attribute category, compared to the proximate vehicle; obtaining, by the system, second audio content based on the target vehicle and the user preference, wherein the second audio content describes a comparison between the proximate vehicle attribute and a target vehicle attribute of the target vehicle, wherein the target vehicle attribute corresponds to the vehicle attribute category; and outputting, by the system, the first audio content and the second audio content.

In some implementations, a non-transitory computer-readable medium storing a set of instructions includes one or more instructions that, when executed by one or more processors of a device, cause the device to: detect that the device is within proximity of a first vehicle; transmit, based on detecting that the device is within proximity of the first vehicle, audio generation information that includes a user identifier, associated with a user of the device, and information that identifies the first vehicle; receive, based on transmitting the audio generation information, first audio content based on the first vehicle and one or more vehicle attribute categories associated with the user identifier, wherein the first audio content describes one or more first attributes of the first vehicle corresponding to the one or more vehicle attribute categories; receive, based on transmitting the audio generation information, second audio content based on a second vehicle and the one or more vehicle attribute categories, wherein the second audio content describes a comparison between the one or more first attributes and one or more second attributes of the second vehicle corresponding to the one or more vehicle attribute categories; and output the first audio content and the second audio content.

### BRIEF DESCRIPTION OF THE DRAWINGS

FIGS. 1A-1H are diagrams of an example implementation relating to proximity-based audio content generation.

FIG. 2 is a diagram of an example environment in which systems and/or methods described herein may be implemented.

FIG. 3 is a diagram of example components of one or more devices of FIG. 2.

FIG. 4 is a flowchart of an example process relating to proximity-based audio content generation.

### DETAILED DESCRIPTION

The following detailed description of example implementations refers to the accompanying drawings. The same reference numbers in different drawings may identify the same or similar elements.

Searching for a vehicle can be an unpleasant experience for many users due to the amount of information available. Locating a vehicle, checking for vehicle buying eligibility, and/or exploring payment options is a tedious and time consuming process. Additionally, due to the amount of information available, it is difficult to identify attributes that are important to the user. Moreover, many users prefer to see a vehicle in person before purchasing a vehicle (e.g., rather than purchasing the vehicle entirely online). However, when visiting vehicle dealership lots, users typically require the assistance of dealership representatives to receive additional information about vehicles (e.g., other than what is listed on a window sticker). However, many users dread dealing with such representatives and feel that the representatives are trying to sell vehicles that profit their interests. It is difficult to obtain information about a vehicle or comparison information comparing different vehicles without speaking with a representative. Thus, many users wish to avoid dealing with the representatives but lack the capabilities to do so.

Therefore, a customized vehicle shopping experience is needed that does not rely on a representative to provide information about a vehicle. For example, audio content about a vehicle can be provided to a user when the user is located near the vehicle in a lot. However, this introduces several technical problems associated with generating and providing the audio content. One technical problem is that a system needs to identify when a user is in a relevant location near the vehicle or is looking at or inspecting the vehicle to provide the audio content at the relevant time (e.g., using a wireless communication technology, beacon technology, or a geographic positioning system, among other examples). Another technical problem is that the audio content needs to be automatically generated in real-time while including content that is specific to the user that is looking at or inspecting the vehicle. It is technically difficult to identify when a specific user is near a vehicle and to identify information that would be relevant to that specific user. Additionally, it is technically difficult to differentiate between different users if multiple users are looking at or inspecting the same vehicle at the same time.

Another technical problem is that there may be a large amount of information available about different vehicle attribute categories (e.g., stored in a database), such as make, model, year, fuel economy, price, safety information, warranty information, and/or installed optional equipment, among other examples. It is technically difficult to generate customized audio content for a vehicle and a user due to the amount of information available and the different preferences each user may have, leading to large number of possible options of audio content that may be provided, which leads to technical difficulties with real-time audio generation. For example, each vehicle may have a large amount of information available to be provided to users, but each user may have different preferences for types of information that are important to that user. Further, it may be necessary to identify information associated with other vehicles that also may be of interest to the user and generate comparison information comparing vehicle attribute categories of the different vehicles. Identifying comparison vehicles or target vehicles that may be of interest to a user requires an analysis of a user profile and of vehicle attributes of many different vehicles. As such, it is difficult to automatically generate customized audio content for a user that identifies relevant information about the vehicle.

In some implementations described herein, to solve the problems described above, a system is provided that enables proximity-based audio content generation for a vehicle. The system may receive an indication that a user device is within a proximity (e.g., a communicative proximity and/or a threshold proximity) of a vehicle. The system may obtain a user profile, associated with the user device, that indicates one or more vehicle attribute categories indicated in the user profile as being of interest to the user of the user device. The system may obtain (e.g., identify and/or generate) audio content that describes one or more vehicle attributes of the vehicle corresponding to the one or more vehicle attribute categories that are of interest to the user.

In some implementations, the system may obtain (e.g., identify and/or generate) comparison audio content that a comparison between the one or more vehicle attributes of the vehicle and one or more vehicle attributes of a second vehicle. The second vehicle may be a vehicle identified in a data structure associated with the user profile (e.g., a comparison vehicle that the user has previously looked at or considered) or a vehicle that is located near the first vehicle (e.g., a target vehicle located on the same lot as the vehicle the user is currently located near).

In some implementations, to solve the technical problems of generating the customized audio content described above, the system may use natural language processing or natural language generation, text-to-speech, and/or similar techniques to generate audio content based on text information stored in a database. For example, the system may use a formula or template that includes static portions (e.g., that apply regardless of vehicle) and dynamic portions (e.g., that are specific to a vehicle or comparison). The system may identify the static portions and may fill in or insert information for the dynamic portions based on information stored in the database to generate the audio content.

As a result, the system may enable generation of customized audio content about a vehicle that is specific to a user who is located proximate to the vehicle. The system may be enabled to identify relevant vehicle attribute information for a user from a database, generate audio content for the user at a relevant time (e.g., when the user or user device is located near the vehicle), and provide the audio content to the user. This conserves significant computing resources and/or network resources that would have otherwise been used by the user to search for a vehicle, locate the vehicle, check for vehicle buying eligibility, locate vehicle attributes relevant to the user, and/or compare different vehicles, among other examples. Moreover, providing the comparison audio content conserves computing resources (e.g., processing resources) that would otherwise been used providing audio content for each vehicle separately (e.g., and thereby requiring the user or user device to perform the comparison).

Therefore, the system may identify relevant information about one or more vehicles for a user (e.g., based on the user profile) from a database containing a large amount of information for many vehicles. The system may provide the information as audio content to the user at a relevant time (e.g., when the user or user device is located proximate to the vehicle). A user may visit a vehicle lot and listen to the audio content when the user approaches or inspects a vehicle on the vehicle lot. The user may be provided with relevant information of different vehicle attributes about the vehicle that are of interest to the user. Moreover, the user may be provided with comparison audio content about a second vehicle that may be of interest to the user. As a result, a customized car shopping experience may be provided for the user that does not require the user to interact with representatives of vehicle lot.

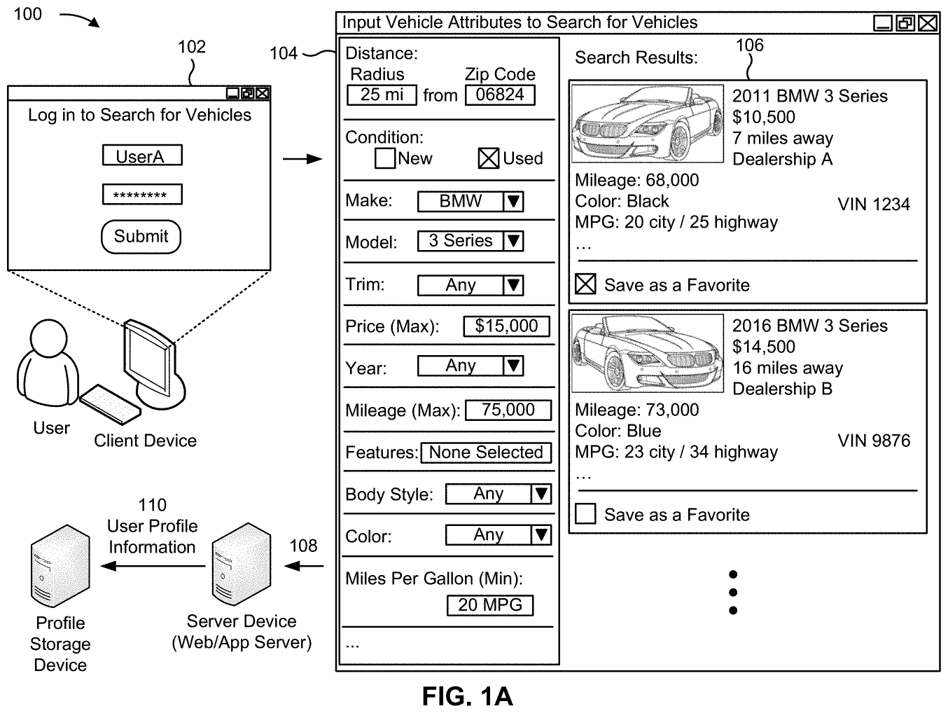

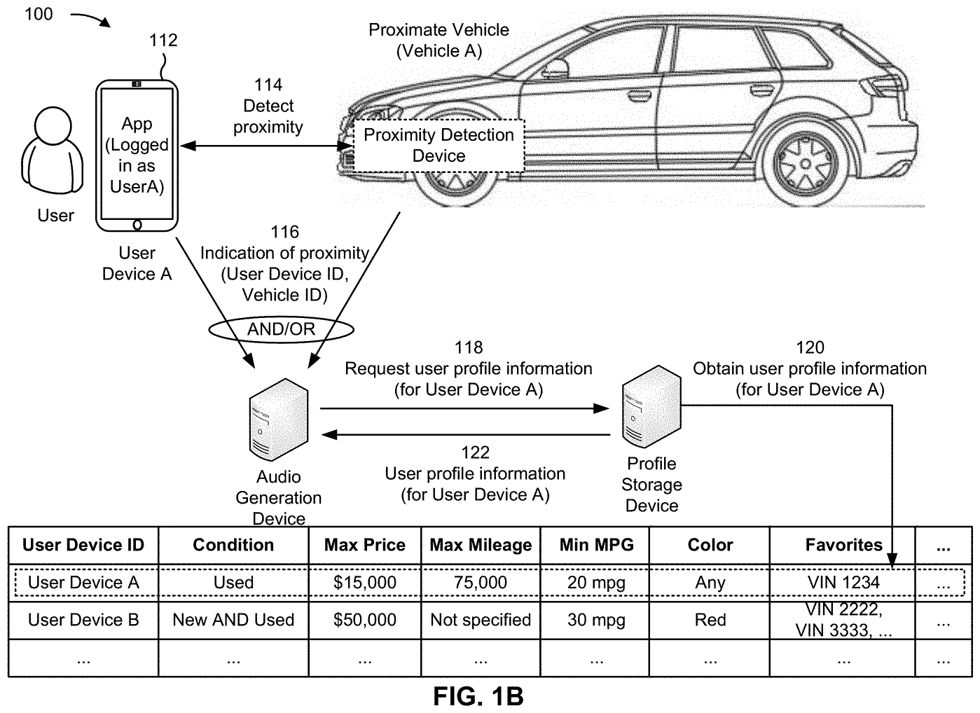

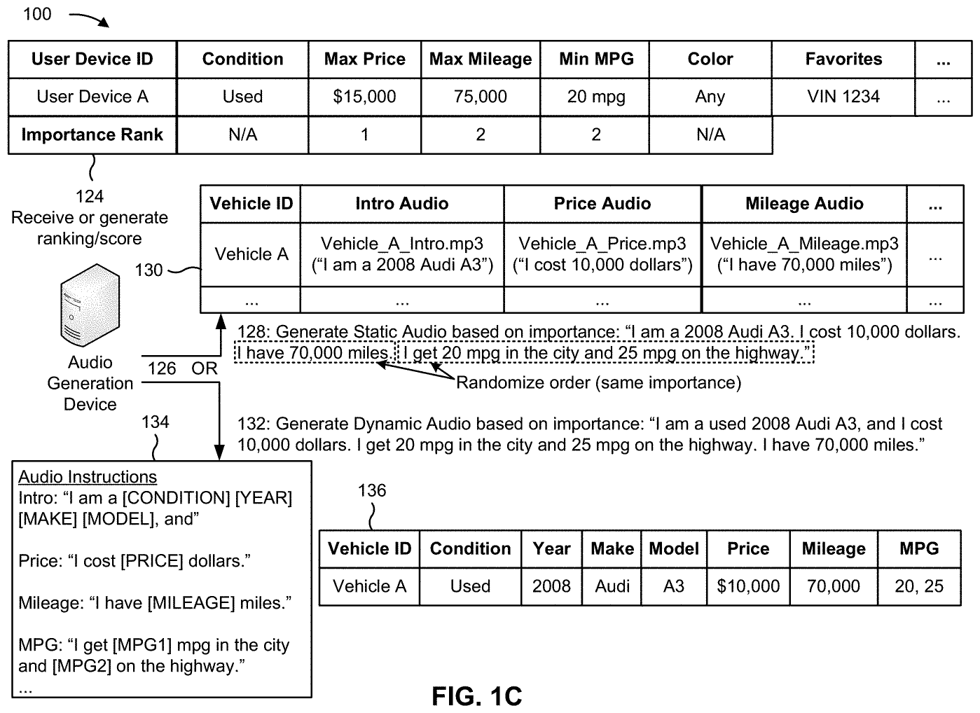

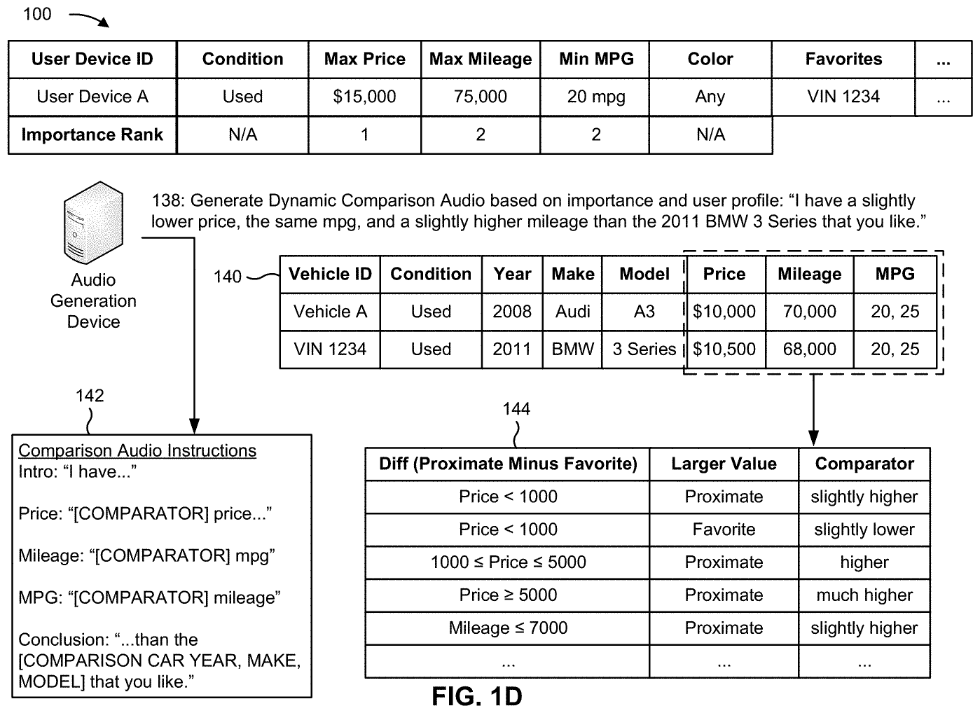

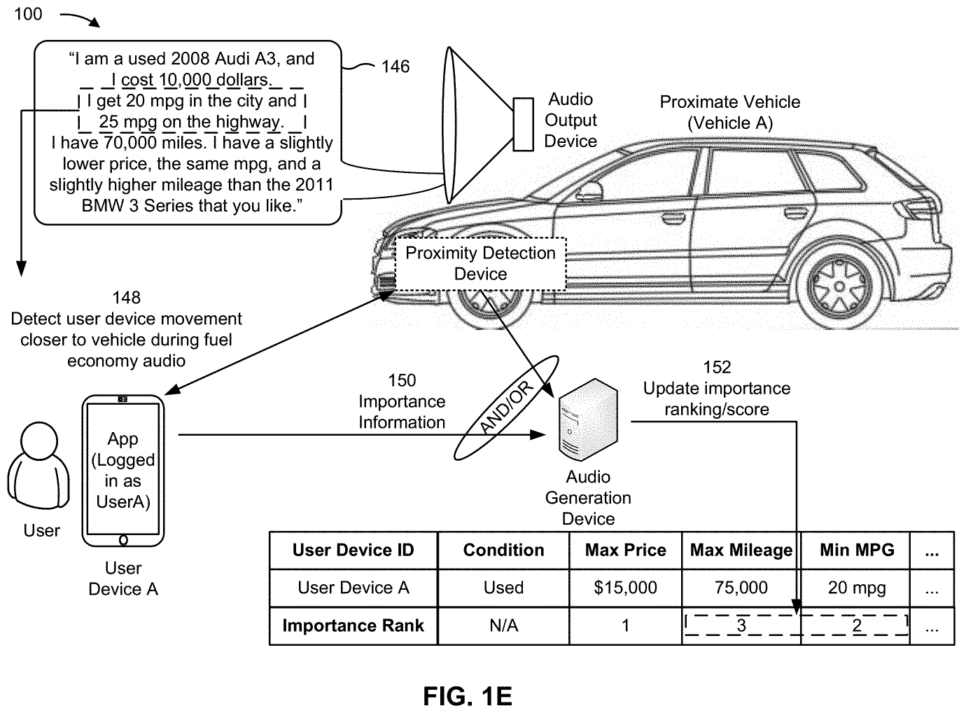

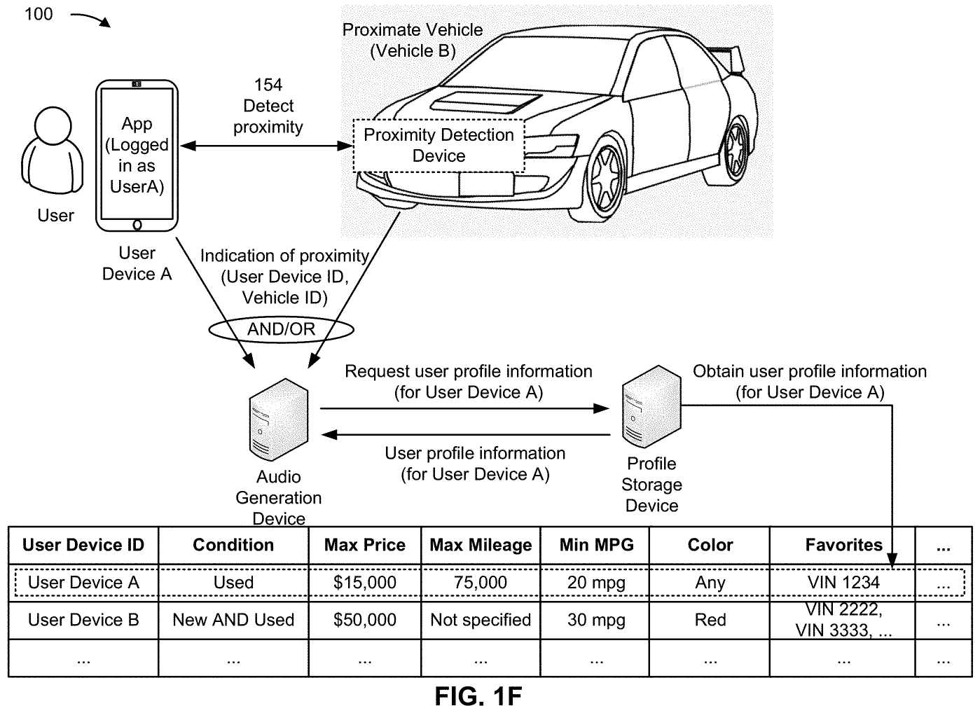

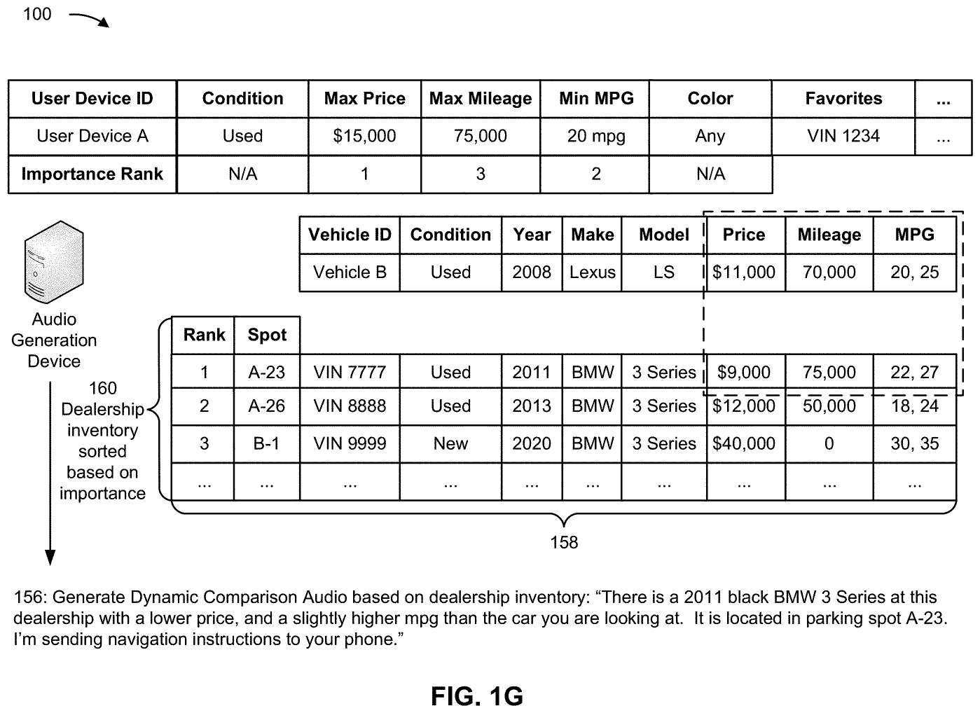

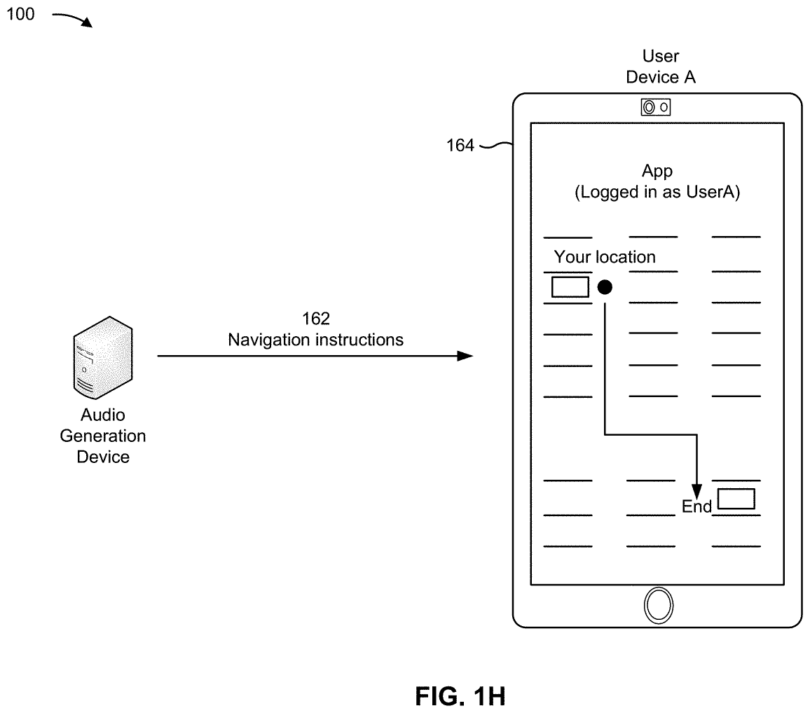

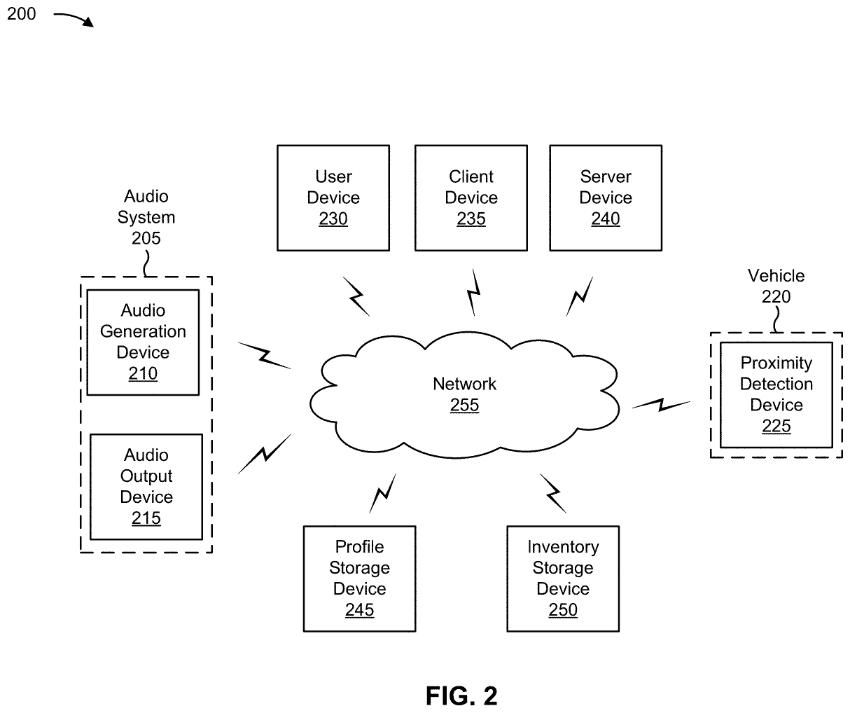

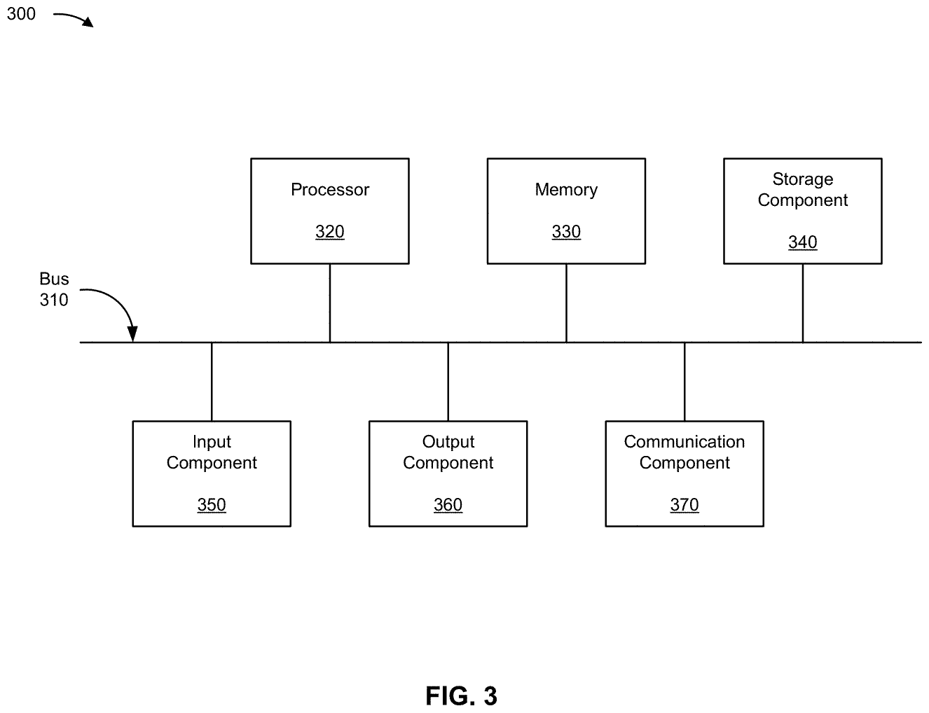

FIGS. 1A-1H are diagrams of an example 100 associated with proximity-based audio content generation. As shown in FIGS. 1A-1H, example 100 includes a client device, a server device, a profile storage device, a user device, a proximity detection device, an audio generation device, and an audio output device. These devices are described in more detail in connection with FIGS. 2 and 3.

As shown in FIG. 1A, the client device may be associated with a user. As shown by reference number 102, the user may use the client device to log in (e.g., using credentials associated with the user) to a platform for searching for vehicle and/or for storing vehicle attribute preferences of the user. As shown by reference number 104, the user (via the client device) may search for vehicle using the platform based on a set of vehicle attribute categories, such as location (e.g., physical location of the vehicle), condition (e.g., new or used), make, model, trim, price (e.g., minimum price, maximum price, and/or a price range), year (a specific year, minimum year, a maximum year, and/or a range of years), current mileage (e.g., a maximum number of miles currently on the vehicle and/or a range of number of miles currently on the vehicle), features, body style, color, and/or fuel economy (e.g., a minimum miles per gallon (MPG) attribute of the vehicle), among other examples. As shown by reference number 106, the platform may provide the user (e.g., via the client device) with a search report indicating one or more matching vehicles based on the search input by the user. The user may provide (e.g., via the client device) an input indicating one or more vehicles in the search report as being of interest to the user (e.g., by favoriting or saving a profile of the one or more vehicles on the platform).

In some implementations, the user may input (e.g., via the client device) an importance or a ranking of different vehicle attribute categories. For example, the user may indicate that fuel economy is more important to the user than make or model. As another example, the user may indicate that the condition (e.g., new or used) is more important than color. In some implementations, the user may rank the set of vehicle attribute categories from most important to least important. In some implementations, the platform (e.g., the server device associated with the platform) may determine or identify one or more vehicle attribute categories that are of interest to the user (e.g., without an explicit input from the user). For example, the server device may analyze one or more searches perform by the user via the platform, one or more vehicles indicated as being of interest to the user, and/or settings of the user profile in the platform to determine or identify one or more vehicle attribute categories that are of interest to the user. The server device may analyze a browsing history of the user when using the platform to determine or identify one or more vehicle attribute categories that are of interest to the user.

As shown by reference number 108, content generated based on user interactions with the platform (e.g., searches performed, inputs, and/or browsing history) may be provided to the server device associated with the platform. As shown by reference number 110, the server device may transmit user profile information (e.g., indicating one or more vehicle attribute categories that are of interest to the user, one or more values or inputs for the one or more vehicle attribute categories, and/or one or more vehicles that are of interest to the user) to the profile storage device. The profile storage device may populate a user profile associated with the user that indicates that user profile information. For example, the profile storage device may store the user profile information (e.g., in a data structure or database) as being associated with the user. In some implementations, the profile storage device may store the user profile information as being associated with the user by linking or mapping an identifier associated with the user (e.g., a user name, an identifier of a user device associated with the user, an identifier of the client device, and/or an identifier of the user profile on the platform) with the user profile information in the data structure or database.

As shown in FIG. 1B, the user may visit a vehicle lot (e.g., a vehicle dealership) to browse different vehicles. As shown by reference number 112, the user may be associated with (e.g., may carry or wear) a user device, and the user device may be executing an application associated with proximity-based audio content generation for vehicles and/or associated with the platform described above in connection with FIG. 1A. The user may log in to the application, via the user device, using credentials associated with the user (e.g., as user A logged in on user device A).

In some implementations, the user and/or user device may approach a vehicle, shown as “Vehicle A.” Vehicle A may be referred to herein as a proximate vehicle (e.g., a vehicle located proximate to or within a threshold proximity of the user device). The proximate vehicle may include or be associated with a proximity detection device that is capable of detecting when a user device is located proximate to (e.g., within a threshold proximity or a communicative proximity of) the proximity detection device. As shown by reference number 114, the proximity detection device may detect that a user device is within a threshold proximity (e.g., distance) of the proximity-detection device. In some implementations, the proximity detection device may detect that the user device is within a communicative proximity of the proximity detection device, meaning that the proximity detection device detects the user device using a communication protocol, such as a protocol of a personal area network (PAN) (e.g., Bluetooth, Bluetooth Low Energy (BLE), and/or Wi-Fi), a near-field communication (NFC) protocol, and/or a radio frequency identification (RFID) network, among other examples. In some implementations, the proximity detection device may identify or obtain a user device identifier (e.g., “User Device A” in FIG. 1B) associated with the user device based on detecting that the user device is located proximate to the proximity detection device.

In some implementations, the proximity detection device may use a system to analyze user interactions to determine when the user device is within a proximity of the proximity detection device. For example, the proximity detection device may use one or more cameras or sensors to perform facial recognition, gaze tracking, eye tracking, and/or location tracking, among other examples, to determine when a user is looking at or physically located near the proximity detection device. In some implementations, the proximity detection device may use one or more of the above techniques in combination with the detection that the user device is located proximate to the proximity detection device to obtain a more accurate determination of when the user is interested in, inspecting, or looking at the proximate vehicle.

In some implementations, the user device may determine when the user device is within a proximity of a proximity detection device. For example, the user device may receive and/or obtain a list of proximity detection device identifiers (e.g., network identifiers) associated with a geographic area (e.g., a geofence). For example, the user device may receive a notification upon entering the geographic area (e.g., associated with the vehicle lot). The notification may indicate that information regarding the proximity detection device and/or proximate vehicles is available and may prompt a user to provide input to permit such information to be downloaded or obtained by the user device. Upon receiving such user input, the user device may obtain the list of proximity detection device identifiers. The user device may use the list of proximity detection device identifiers to determine when the user device is within communicative proximity of a proximity detection device having a proximity detection device identifier included in the list.

As shown by reference number 116, the proximity detection device and/or the user device may transmit, to the audio generation device, an indication of proximity between the proximate vehicle and the user device (and/or the user). The indication of proximity may identify the user device identifier, a user profile identifier, and/or the proximate vehicle identifier (e.g., a vehicle identification number (VIN) or other identifier), among other examples. As shown by reference number 118, based on receiving the indication of proximity, the audio generation device may transmit, to the profile storage device, a request for user profile information associated with the user device identifier and/or user profile identifier. In some implementations, the proximity detection device and/or the user device may transmit, to the audio generation device, a request for audio content (e.g., in addition to or included in the indication of proximity) associated with the proximate vehicle.

As shown by reference number 120, the profile storage device may obtain the user profile information associated with the user device (e.g., User Device A) from the data structure or database stored by the profile storage device. The user profile information may be received and stored by the profile storage device as described above in connection with FIG. 1A. For example, the profile storage device may search or query the data structure or database using the user device identifier and/or user profile identifier to identify the user profile information associated with the user device (and/or the user profile associated with the user). As shown by reference number 122, the profile storage device may transmit, to the audio generation device, an indication of the user profile information. For example, the profile storage device may transmit an indication of one or more relevant vehicle attribute categories (e.g., that are of interest to the user), one or more vehicles that of interest to the user (e.g., comparison vehicles), and/or a value or input associated with the one or more relevant vehicle attribute categories.

In some implementations, the profile storage device may transmit an indication of a set of vehicle attribute categories (e.g., that includes the one or more relevant vehicle attribute categories and one or more other vehicle attribute categories), and the audio generation device may determine or identify the one or more relevant vehicle attribute categories, as described in more detail below. In some implementations, the audio generation device may update user profile information based on a user interaction with a proximate vehicle. For example, audio generation device may receive a proximity indication as described above. The audio generation device may track and/or store vehicle attributes of the proximate vehicle in the user profile information. In some implementations, the audio generation device may update the user profile information to indicate the proximate vehicle information based on an amount of time that the user device remains within a proximity of the proximate vehicle. In other words, if the user device remains within the proximity of the proximate vehicle for a threshold amount of time, then the audio generation device may update the user profile information to indicate the proximate vehicle information.

As shown in FIG. 1C, and by reference number 124, the audio generation device may receive (e.g., from the profile storage device) or may generate a ranking or score for the one or more relevant vehicle attribute categories that indicates an importance of each vehicle attribute category to the user. For example, the audio generation device may identify or determine an importance rank for each of the one or more relevant vehicle attribute categories. An importance rank may indicate an importance on a scale (e.g., from 1 to 5 with 1 being the most important and 5 being the least important). In some implementations, the importance rank may indicate a rank of the one or more relevant vehicle attribute categories from a most important vehicle attribute category to a least important vehicle attribute category. In some implementations, the audio generation device may associate a subset of vehicle attribute categories (from the set of vehicle attribute categories) with an importance rank based on the user profile information. For example, the subset of vehicle attribute categories may be the one or more relevant vehicle attribute categories described above.

As shown by reference number 126, the audio generation device may obtain (e.g., identify and/or generate) audio content associated with the proximate vehicle based on the importance of each vehicle attribute category to the user (e.g., determined or identified as described above). The audio content associated with the proximate vehicle may be referred to herein as proximate vehicle audio content and may identify information (e.g., inputs or values) about the proximate vehicle for one or more vehicle attribute categories (e.g., for the one or more relevant vehicle attribute categories). The audio generation device may obtain information associated with the proximate vehicle corresponding to a set of vehicle attribute categories from a data structure or database. For example, the audio generation device (or another device associated with the audio generation device) may search or query the data structure based on the vehicle identifier of the proximate vehicle to identify the information associated with the proximate vehicle corresponding to the set of vehicle attribute categories. For example, the audio generation device may identify (or receive an indication) that the proximate vehicle is associated with an input of “Used” for the vehicle attribute category of “Condition,” an input of “2008” for the vehicle attribute category of “Year,” an input of “Audi” for the vehicle attribute category of “Make,” an input of “A3” for the vehicle attribute category of “Model,” an input of “$10,000” for the vehicle attribute category of “Price,” an input of “70,000” for the vehicle attribute category of “Mileage,” and an input of “20, 25” (e.g., corresponding to a city MPG and highway MPG) for the vehicle attribute category of “Fuel Economy.”

In some implementations, the proximate vehicle audio content may identify information about the proximate vehicle corresponding to one or more fixed or set vehicle attribute categories and the one or more relevant vehicle attribute categories (e.g., that are not included in the one or more fixed or set vehicle attribute categories). For example, the proximate vehicle audio content may always identify information corresponding to the proximate vehicle's price, make, model, and/or mileage (e.g., regardless of the user profile information). For example, the proximate vehicle audio content may include an introduction portion that identifies the information about the proximate vehicle corresponding to one or more fixed or set vehicle attribute categories. For example, the introduction portion may follow a formula or template of “I am a [Year] [Make] [Model] priced at [Price],” such as “I am a 2008 Audi A3 priced at $10,000.” If the user profile information indicates that one or more other vehicle attribute categories are important to the user, then the proximate vehicle audio content may also identify information about the proximate vehicle corresponding to the one or more other vehicle attribute categories.

An order or sequence of the proximate vehicle audio content may be based on the importance rank of each vehicle attribute category identified in the proximate vehicle audio content. For example, the audio generation device, when obtaining the proximate vehicle audio content, may order the proximate vehicle audio content based on the importance rank, such that more important information to the user about the proximate vehicle is presented before less important information.

As shown by reference number 128, in some implementations, the audio generation device may generate the proximate vehicle audio content using a static audio generation technique. The static audio generation technique may include combining or compiling a set of audio content files or segments (e.g., that are static or pre-defined) that are stored by the audio generation device. As shown by reference number 130, the audio generation device may store audio content that identifies information corresponding to each of the inputs associated with the proximate vehicle corresponding to the set of vehicle attribute categories. For example, the audio generation device may store introduction audio content segment for the proximate vehicle that identifies a year, make, and model of the proximate vehicle (e.g., “I am a 2008 Audi A3”). The audio generation device may store price audio content segment that identifies the price of the proximate vehicle (e.g., “I cost 10,000 dollars”). The audio generation device may store mileage price audio content segment that identifies the mileage of the proximate vehicle (e.g., “I have 70,000 miles”). The audio generation device may store audio content for each vehicle attribute category, included in the set of vehicle attribute categories, in a similar manner.

The audio generation device may identify and/or retrieve one or more stored audio content files or segments based on the importance of each vehicle attribute category to the user (e.g., determined or identified as described above). For example, as shown in FIG. 1C, if the audio generation device identifies that the vehicle attribute categories of price, mileage, and fuel economy are of importance to the user, the audio generation device may identify and/or retrieve a price audio content segment, a mileage audio content segment, and a fuel economy audio content segment that are stored by the audio generation device and associated with the proximate vehicle. The audio generation device may obtain the proximate vehicle audio content by combining or compiling the identified and/or retrieved stored audio content files.

As described above, when compiling the stored audio content files, the audio generation device may order or determine a sequence of the stored audio content segments based on an importance rank of a corresponding vehicle attribute category. For example, as shown in FIG. 1C, the vehicle attribute category of price may have an importance rank of 1, and the vehicle attribute categories of mileage and fuel economy may have an importance rank of 2. Therefore, when compiling the stored audio content segments, the audio generation device may place the price audio content segment before the mileage audio content segment and the fuel economy audio content segment (e.g., as an importance rank of 1 indicates a higher importance than an importance rank of 2). Because the mileage vehicle attribute category and the fuel economy vehicle attribute category have the same importance rank, the audio generation device may order the mileage audio content segment and the fuel economy audio content segment according to a pre-determined, pre-defined, and/or random order. In some implementations, when compiling the stored audio content segments, the audio generation device may place fixed audio content (e.g., that is included in the proximate vehicle audio content regardless of the user profile information, such as the introduction audio content segment) before any custom audio content segments (e.g., audio content that is included based on the user profile information). Therefore, as shown in FIG. 1C, the audio generation device may obtain or generate proximate vehicle audio content according to the static audio generation technique that includes an introduction audio content segment, a price audio content segment, a mileage audio content segment, and a fuel economy mileage content segment, ordered based on the importance to the user. This may result in a proximate vehicle audio content of “I am a 2008 Audi A3. I cost 10,000 dollars. I have 70,000 miles. I get 20 MPG in the city and 25 MPG on the highway.”

As shown by reference number 132, in some implementations, the audio generation device may generate the proximate vehicle audio content using a dynamic audio generation technique. The dynamic audio generation technique may include the audio generation device following a set of audio instructions to generate the proximate vehicle audio content. As shown by reference number 134, the audio instructions may identify, for a vehicle attribute category, a formula or template to be used to generate the audio content corresponding to the vehicle attribute category. The formula or template may include one or more static parts and one or more dynamic parts. The dynamic parts may be fields in which dynamic information, corresponding to the proximate vehicle, is to be input or inserted by the audio generation device. As shown by reference number 136, the dynamic information may be stored in a data structure (e.g., of the audio generation device). For example, for a vehicle attribute category of “Price,” the audio instructions may identify static parts (shown in normal text in FIG. 1C) and dynamic parts (shown between brackets in FIG. 1C) of “I cost [PRICE] dollars.” Therefore, when generating the price audio content, the audio generation device may insert the price of the proximate vehicle to result in price audio content of “I cost 10,000 dollars.” As another example, for an introduction audio content, the audio instructions may identify static parts (shown in normal text) and dynamic parts (shown between brackets) of “I am a [CONDITION] [YEAR] [MAKE] [MODEL], and . . . ” Therefore, when generating the price audio content, the audio generation device may insert the price of the proximate vehicle to result in an introduction audio content of “I am a used 2008 Audi A3, and . . . ” As shown in FIG. 1C, when generating the proximate vehicle audio content, the audio generation device may order or determine a sequence of audio content segments based on an importance rank in a similar (or the same) manner as described above in connection with the static audio generation technique.

In some implementations, the proximate vehicle audio content may identify the user associated with the user device. For example, multiple user devices may be within a proximity of the proximity detection device and the proximate vehicle. Therefore, the audio generation device may generate the proximate vehicle audio content to identify the user associated with the user device and the user profile information. For example, the audio generation device may identify a user's name or a user identifier based on the user profile information. The audio generation device may generate a user identification audio segment that identifies the user to which the proximate vehicle audio content is relevant (e.g., the user associated with the user profile used to generate the proximate vehicle audio content). For example, the user identification audio segment may be “Hi, Bob . . . ,” and/or “Hi, UserXYZ . . . ,” among other examples.

As shown in FIG. 1D, and by reference number 138, the audio generation device may obtain (e.g., generate and/or identify) comparison audio content. The comparison audio content may compare vehicle attributes of the proximate vehicle to a second vehicle. For example, as shown by reference number 140, the comparison audio content may compare vehicle attributes of the proximate vehicle to vehicle attributes of a vehicle indicated in the user profile information (e.g., a comparison vehicle). For example, the user profile information may indicate one or more comparison vehicles that the user has marked, flagged, and/or favorited, indicating that the one or more comparison vehicles are of interest to the user. The user profile information may identify a vehicle identifier of the one or more comparison vehicles (e.g., VIN 1234, as shown in FIG. 1D). In some implementations, the user profile information may identify values for vehicle attributes of the one or more comparison vehicles. In some implementations, the comparison vehicle may be a vehicle that the user previously interacted with (e.g., that the user device was within a proximity of) at the same vehicle lot. For example, the audio generation device may track and/or store vehicles that the user device comes into proximity with (e.g., as described above in connection with FIG. 1B). In some implementations, the audio generation device may request, identify, and/or retrieve the values for vehicle attributes of the one or more comparison vehicles from a database (e.g., from the profile storage device, the server device, or another device).

In some implementations, the audio generation device may generate the comparison audio content in a similar manner as the dynamic audio generation technique described above. For example, as shown by reference number 142, the audio generation device may identify comparison audio instructions that indicate a formula or template for comparisons associated with different vehicle attribute categories. As shown by reference number 144, the dynamic parts of the formula or template may be associated with a comparator to be identified and inserted by the audio generation device. The comparator may indicate a difference in a vehicle attribute of the proximate vehicle when compared to the vehicle attribute of a comparison vehicle, or vice versa. As shown in FIG. 1D, comparison audio instructions may include an introduction audio segment and/or a conclusion audio segment to be placed or sequenced at the start or end of the comparison audio content. For example, the introduction audio segment may identify the proximate vehicle and/or indicate the start of a comparison. The conclusion audio segment may indicate information associated with the comparison vehicle and/or indicate that the comparisons included in the comparison audio content are with respect to the comparison vehicle. For example, as shown in FIG. 1D, the formula or template for the conclusion audio segment may be “than the [COMPARISON CAR YEAR, MAKE, MODEL] that you like.” In some implementations, the audio generation device may generate the comparison audio content in a similar manner as the static audio generation technique described above (e.g., by identifying and/or retrieving predetermined or stored audio content segments for different comparisons), alone or in combination with the dynamic audio generation technique described above.

The audio generation device may determine comparison information associated with the proximate vehicle and a comparison vehicle. For a vehicle attribute category, the audio generation device may determine a difference between a vehicle attribute of the proximate vehicle and the vehicle attribute of a comparison vehicle. For example, as shown in FIG. 1D, for a vehicle attribute category of “Price,” the audio generation device may identify that the proximate vehicle has a price of $10,000 and the comparison vehicle has a price of $10,500. As a result, the audio generation device may determine that the difference in price between the proximate vehicle and the comparison vehicle is $500, with the comparison vehicle having a higher (or larger value for the) price. The audio generation device may use a set of rules or guidelines for identifying a comparator associated with the difference. The comparator may indicate a relative size of the difference (e.g., small difference, medium difference, and/or large difference) and may indicate which vehicle is associated with a larger value. For example, as shown in FIG. 1D, if the difference in price is less than $1,000, then the comparator may indicate that the difference is small (e.g., using words such as “slightly,” “a little,” or “barely”). If the difference in price is between $1,000 and $5,000, then the comparator may indicate that the difference is normal (e.g., by only indicating which vehicle is associated with the higher price). If the difference in price is greater than or equal to $5,000, then the comparator may indicate that the difference is large (e.g., by using words like “much,” “significantly,” “a lot,” or “way”). In some implementations, if there is no difference (e.g., the proximate vehicle and the comparison vehicle have the same value or information for a vehicle attribute category), then the comparator may indicate that there is no difference for that vehicle attribute category (e.g., by using words such as “the same” or “identical”). The audio generation device may determine a comparator for one or more vehicle attribute categories, such as for the one or more relevant vehicle attribute categories, in a similar manner as described above.

In some implementations, the audio generation device may obtain (e.g., identify and/or generate) the comparison audio content based on importance of the vehicle attribute categories (e.g., determined based on the user profile information, as described above). For example, the audio generation device may determine a sequence of comparison audio segments based on the importance of the vehicle attribute categories to the user (e.g., placing the more important vehicle attributes first). For example, as shown in FIG. 1D, the audio generation device may order a price comparison audio segment before a mileage comparison audio segment and before a fuel economy comparison audio segment. The audio generation device may generate the comparison audio content by combining or compiling one or more comparison audio segments.

For example, as shown in FIG. 1D, the audio generation device may combine a comparison introduction audio segment, a price comparison audio segment, a mileage comparison audio segment, a fuel economy comparison audio segment, and a comparison conclusion audio segment to generate comparison audio content between the proximate vehicle and the comparison vehicle. Therefore, the comparison audio content between the proximate vehicle and the comparison vehicle may be “I have a slightly lower price, the same MPG, and a slightly higher mileage than the 2011 BMW 3 Series that you like.”

In some implementations, the audio generation device may generate the comparison audio content automatically based on the user profile information (e.g., if the user profile information identifies a comparison vehicle). In some implementations, the audio generation device may generate the comparison audio content based on a command received from the user device or another device. For example, the user may provide an input to the user device requesting a comparison between the proximate vehicle and a comparison vehicle. In some implementations, the request may indicate information associated with the comparison vehicle (e.g., an identifier of the comparison vehicle and/or one or more vehicle attributes of the comparison vehicle). In some implementations, the user may verbally request a comparison between the proximate vehicle and a comparison vehicle (e.g., “compare this vehicle to the 2011 BMW I like,” or “compare this vehicle to the 2005 Chevy I was just looking at.”). A device (e.g., the user device, the audio generation device, the proximity detection device, or another device) may capture or record the verbal request and may perform a voice-to-text analysis (e.g., using natural language processing or another technique) to identify the request and the comparison vehicle.

As shown in FIG. 1E, and by reference number 146, the audio output device may output the proximate vehicle audio content and/or the comparison audio content. For example, the proximate vehicle audio content and/or the comparison audio content may be played or output via the audio output device such that the user is enabled to hear or listen to the proximate vehicle audio content and/or the comparison audio content. In some implementations, the audio output device may be included in the user device (e.g., the audio output device may be the user device or a speaker of the user device). For example, the user device may obtain (e.g., receive) audio content described herein and may output the audio content via the audio output device. In some implementations, the audio output device may be included in, or co-located with, the proximate vehicle.

As shown by reference number 148, the user device and/or the proximity detection device may detect a movement of the user device (or of the user) while the proximate vehicle audio content and/or the comparison audio content is being played or output. For example, the user (and the user device) may move closer to, or further from, the proximity detection device while a segment of the proximate vehicle audio content and/or the comparison audio content is being played or output. As shown in FIG. 1E, the user device and/or the proximity detection device may detect that the user device is moving closer to the proximate vehicle while a fuel economy audio segment is being played or output by the audio output device.

As shown by reference number 150, the user device and/or the proximity detection device may transmit, to the audio generation device, an indication of the detected movement of the user device, which may indicate a modification to importance information. In some implementations, the user device and/or the proximity detection device may indicate a segment of the audio content that was being played when the movement was initiated. In some implementations, the audio generation device may determine or identify the segment of the audio content that was being played when the movement was initiated.

As shown by reference number 152, the audio generation device may modify or update importance information (e.g., an importance rank or importance score) of a vehicle attribute category associated with the segment of the audio content that was being played when the movement was initiated. For example, if the audio generation device determines that the user device is moving further from the proximate vehicle when the segment of the audio content is played, then the audio generation device may modify importance information of the vehicle attribute category associated with the segment to indicate a lower importance rank or score (e.g., indicating that the vehicle attribute category is less important to the user than previously indicated). If the audio generation device determines that the user device is moving closer to the proximate vehicle when the segment of the audio content is played, then the audio generation device may modify importance information of the vehicle attribute category associated with the segment to indicate a higher importance rank or score (e.g., indicating that the vehicle attribute category is more important to the user than previously indicated).

In some implementations, the audio generation device may receive an indication of an update to importance information from the user device. For example, the user may provide an input to the user device indicating that an importance for one or more vehicle attribute categories should be updated. The user device may transmit, to the audio generation device, an indication to update the importance of the one or more vehicle attribute categories. In some implementations, the audio generation device may receive an indication of an update to importance information that is based on a movement or action of the user. For example, a device (e.g., the user device, the proximity detection device, or another device) may track a movement of the user, may track facial expressions of the user (e.g., using facial recognition), and/or may perform gaze tracking of the user while the proximate vehicle audio content and/or the comparison audio content is being played or output. The device (e.g., the user device, the proximity detection device, or another device) may indicate the movement or action of the user (e.g., moves closer to the proximate vehicle, a smile, a head nod, and/or a look towards the vehicle) and the segment of the audio content that was being played when the movement or action occurred. The audio generation device may use the movement or action to update the importance information. For example, if a user nods their head or looks towards the proximate vehicle while a segment is being output, the audio generation device may update an importance rank or score to indicate that a vehicle attribute category associated with the segment is more important to the user than previously indicated.

As shown in FIG. 1F, the user device (and the user) may approach another vehicle, shown as “Vehicle B” (e.g., another proximate vehicle). As shown by reference number 154, the user device and/or a proximity detection device of Vehicle B may detect that the user device is within a proximity of Vehicle B in a similar manner as described above in connection with FIG. 1B. The audio generation device may receive the indication of proximity and may obtain (e.g., request, receive, identify, and/or retrieve) user profile information associated with the user device in a similar manner as described above in connection with FIG. 1B.

As shown in FIG. 1G, and by reference number 156, the audio generation device may obtain (e.g., generate and/or identify) comparison audio content comparing the proximate vehicle (e.g., Vehicle B) to a second vehicle located in the same geographic area as the proximate vehicle (e.g., in a same lot or at a same dealership, and/or at a nearby dealership). The second vehicle may be referred to herein as a target vehicle. In some implementations, the target vehicle may be another vehicle included in an inventory of an entity associated with the proximate vehicle (e.g., an entity that is offering the proximate vehicle for sale, such as a dealership).

As shown by reference number 158, the audio generation device may identify the target vehicle based on analyzing target vehicle attributes stored by the audio generation device (or another device). For example, the audio generation device may search or parse an inventory database to identify one or more target vehicles having vehicle attributes that match the user profile information of the user. As shown by reference number 160, the audio generation device may identify the one or more target vehicles based on an importance rank associated with vehicle attribute categories of the user profile information. In some implementations, the audio generation device may use updated importance ranks, as described above (e.g., as shown in FIG. 1G, the fuel economy vehicle attribute category may now be associated with an importance rank of 3, rather than 2). For example, the audio generation device may search or parse an inventory database to identify one or more target vehicles having vehicle attributes that match the user profile information of the user, prioritizing certain vehicle attribute categories according to the importance ranks. In some implementations, the audio generation device may sort the inventory based on matching the user profile information of the user, prioritizing certain vehicle attribute categories according to the importance ranks, to target vehicle attributes in the inventory. The audio generation device may identify a target vehicle based on identifying the vehicle in the inventory that has a best match with the user profile information.

The audio generation device may compare target vehicle attributes of the target vehicle to proximate vehicle attributes of the proximate vehicle in a similar manner as described above in connection with FIG. 1D and the comparison vehicle. For example, the audio generation device may determine a difference between values of target vehicle attributes of the target vehicle and values of proximate vehicle attributes of the proximate vehicle for one or more relevant vehicle attribute categories. The audio generation device may determine a comparator, to be used in a comparison audio segment, based on the difference between values of target vehicle attributes of the target vehicle and values of proximate vehicle attributes of the proximate vehicle.

The audio generation device may obtain (e.g., generate and/or identify) comparison audio content comparing the proximate vehicle (e.g., Vehicle B) to the target vehicle (e.g., target comparison audio content) in a similar manner as described above in connection with FIG. 1D. For example, the audio generation device may obtain the target comparison audio content using a dynamic audio generation technique, a static audio generation technique, and/or using different comparators based on comparing proximate vehicle attributes to target vehicle attributes. For example, as shown in FIG. 1G, the target comparison audio content may be “There is a 2011 black BMW 3 Series at this dealership with a lower price, and a slightly higher mpg than the car you are looking at.” The audio generation device may cause the target comparison audio content to be output via the audio output device, in a similar manner as described above.

In some implementations, for some vehicle attribute categories, the comparison audio content may indicate binary information (e.g., indicating that one vehicle has or does not have a feature or color). For example, for the vehicle attribute category of color, the audio generation device may identify a preferred or desired color. The audio generation device may determine that the proximate vehicle is not in the preferred color, but the target vehicle is in the preferred color. A color comparison audio segment may indicate that the target vehicle is in the preferred color (e.g., “that is in your preferred color,” or “is red”). Similarly, a comparison audio segment may indicate that the target vehicle has one or more features that the proximate vehicle does not have (e.g., “that has heated seats,” “that has a sun roof,” “that has a V6 engine,” or similar comparison audio segments).

In some implementations, the audio generation device may obtain (e.g., generate and/or identify) navigation audio content that identifies a location of the target vehicle and/or navigation instructions indicating how to navigate from the proximate vehicle to the target vehicle. For example, the audio generation device may identify a location of the target vehicle, such as coordinates, a spot in a dealership lot (e.g., a row and spot number), and/or an address of a location of the target device. In some implementations, the audio generation device may determine, identify, and/or obtain navigation instructions to be provided to the user device. The navigation instructions may cause the user device to display or provide navigation instructions to the user, as described in more detail below. The navigation audio content may indicate that the navigation instructions are to be provided to the user device. The audio generation device may obtain (e.g., generate and/or identify) the navigation audio content in a similar manner as described above in connection with the proximate vehicle audio content, the comparison audio content, and/or the target comparison audio content. As shown in FIG. 1G, the navigation audio content may be “It is located in parking spot A-23. I'm sending navigation instructions to your phone.” The audio generation device may cause the navigation audio content to be output via the audio output device, in a similar manner as described above. In some implementations, the audio generation device may cause the navigation audio content to be output, via the audio output device, in connection with (e.g., directly after) the target comparison audio content.

As shown in FIG. 1H, and by reference number 162, the audio generation device may provide, to the user device, the navigation instructions indicating a route from the current user device location to the location of the target vehicle. The navigation instructions may cause the user device to display the navigation instructions. For example, as shown by reference number 164, the application executing on the user device (e.g., described above in connection with FIG. 1B), may display a map of a lot where the proximate vehicle and the target vehicle are located. The navigation instructions may cause the user device to display a route, on the map, from the proximate vehicle location (or user device location) to the target vehicle location. In some implementations, the navigation instruction may cause another application executing on the user device, such as a navigation application, to display and/or provide the route to the target vehicle location.

In some implementations, the audio generation device may be included in the user device. For example, one or more (or all) actions described herein as being performed by the audio generation device may be performed by the user device (or an audio generation device component of the user device). The audio content described above may be output by an audio output device that is included in the user device (e.g., a speaker of the user device). In some implementations, the audio generation device may be a device associated with the entity offering vehicles for sale. In some implementations, the audio generation device may be a remote device (e.g., a cloud-based device) that communicates with devices located at the entity offering vehicles for sale.

As indicated above, FIGS. 1A-1H are provided as an example. Other examples may differ from what is described with regard to FIGS. 1A-1H.

FIG. 2 is a diagram of an example environment 200 in which systems and/or methods described herein may be implemented. As shown in FIG. 2, environment 200 may include an audio system 205 that includes an audio generation device 210 and an audio output device 215, a vehicle 220 that includes a proximity detection device 225, a user device 230, a client device 235, a server device 240, a profile storage device 245, an inventory storage device 250, and a network 255. Devices of environment 200 may interconnect via wired connections, wireless connections, or a combination of wired and wireless connections.

The audio system 205 includes one or more devices capable of generating, identifying, obtaining, and/or outputting audio content, as described elsewhere herein. The audio system may include the audio generation device 210 and/or the audio output device 215. In some implementations, the audio system 205 may be included in, or co-located with, one or more other devices of environment 200. For example, the audio system 205 may be included in, or co-located with, the user device 230 or the vehicle 220, among other examples.

The audio generation device 210 includes one or more devices capable of generating, identifying, and/or obtaining audio content, as described elsewhere herein. For example, the audio generation device 210 may include a computing device, a communication device, a server, such as an application server, a client server, a web server, a database server, a host server, a proxy server, a virtual server (e.g., executing on computing hardware), or a server in a cloud computing system. or a similar type of device.

The audio output device 215 includes one or more devices capable of outputting audio content, as described elsewhere herein. For example, the audio output device 215 may include a speaker or an audio output connection connected to a speaker, earphones, headphones, a stereo, a radio, a headset, a loudspeaker, or a similar type of device.

The vehicle 220 includes any type of vehicle for which a comparison may be sought. For example, vehicle 220 may include an automobile, a car, a truck, a motorcycle, a scooter, a boat, an airplane, a bicycle, and/or the like. As indicated elsewhere herein, although some operations are described herein in connection with vehicles, such operations may be performed in connection with other objects, such as appliances (e.g., home appliances, office appliances, and/or the like), furniture, electronics, and/or the like.

The proximity detection device 225 includes one or more devices capable of sensing a nearby user and/or user device 230, and/or one or more devices capable of communicating with nearby devices (e.g., user device 230). For example, proximity detection device 225 may include one or more sensors, a communication device, a PAN device (e.g., a Bluetooth device, a BLE device, and/or the like), an NFC device, an RFID device, a local area network (LAN) device (e.g., a wireless LAN (WLAN) device), and/or the like. In some implementations, proximity detection device 225 may be integrated into vehicle 220 (e.g., into one or more electronic and/or communication systems of vehicle 220). In some implementations, the proximity detection device 225 may be integrated into an interactive display system. Additionally, or alternatively, proximity detection device 225 may be located near a vehicle 220 or a group of vehicles 220. In some implementations, a single proximity detection device 225 may detect proximity for a corresponding single vehicle 220 (e.g., each vehicle 220 may have its own proximity detection device 225). In some implementations, a single proximity detection device 225 may detect proximity for multiple vehicles 220.

The user device 230 includes one or more devices capable of receiving, generating, storing, processing, and/or providing information associated with proximity-based audio content, as described elsewhere herein. The user device 230 may include a communication device and/or a computing device. For example, the user device 230 may include a wireless communication device, a mobile phone, a user equipment, a laptop computer, a tablet computer, a wearable communication device (e.g., a smart wristwatch, a pair of smart eyeglasses, a head mounted display, or a virtual reality headset), or a similar type of device.

The client device 235 includes one or more devices capable of receiving, generating, storing, processing, and/or providing information associated with user information for a user profile and/or proximity-based audio content, as described elsewhere herein. The client device 235 may include a communication device and/or a computing device. For example, the client device 235 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The server device 240 includes one or more devices capable of receiving, generating, storing, processing, providing, and/or routing information associated with proximity-based audio content, as described elsewhere herein. The server device 240 may include a communication device and/or a computing device. For example, the server device 240 may include a server, such as an application server, a client server, a web server, a database server, a host server, a proxy server, a virtual server (e.g., executing on computing hardware), or a server in a cloud computing system. In some implementations, the server device 240 includes computing hardware used in a cloud computing environment.

The profile storage device 245 includes one or more devices capable of receiving, generating, storing, processing, and/or providing user profile data, as described elsewhere herein. The profile storage device may include a communication device and/or a computing device. For example, the profile storage device 245 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The profile storage device 245 may communicate with one or more other devices of environment 200, as described elsewhere herein.

The inventory storage device 250 includes one or more devices capable of receiving, generating, storing, processing, and/or providing inventory of vehicles and/or information associated with an inventory of vehicles, as described elsewhere herein. The inventory storage device 250 may include a communication device and/or a computing device. For example, the inventory storage device 250 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The inventory storage device 250 may communicate with one or more other devices of environment 200, as described elsewhere herein.

The network 255 includes one or more wired and/or wireless networks. For example, the network 255 may include a wireless wide area network (e.g., a cellular network or a public land mobile network), a local area network (e.g., a wired local area network or a WLAN, such as a Wi-Fi network), a personal area network (e.g., a Bluetooth network), a near-field communication network, a telephone network, a private network, the Internet, and/or a combination of these or other types of networks. The network 255 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the audio system 205, the audio generation device 210, the audio output device 215, the vehicle 220, the proximity detection device 225, the user device 230, the client device 235, the server device 240, the profile storage device 245, and/or the inventory storage device 250. In some implementations, the audio system 205, the audio generation device 210, the audio output device 215, the vehicle 220, the proximity detection device 225, the user device 230, the client device 235, the server device 240, the profile storage device 245, and/or the inventory storage device 250 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

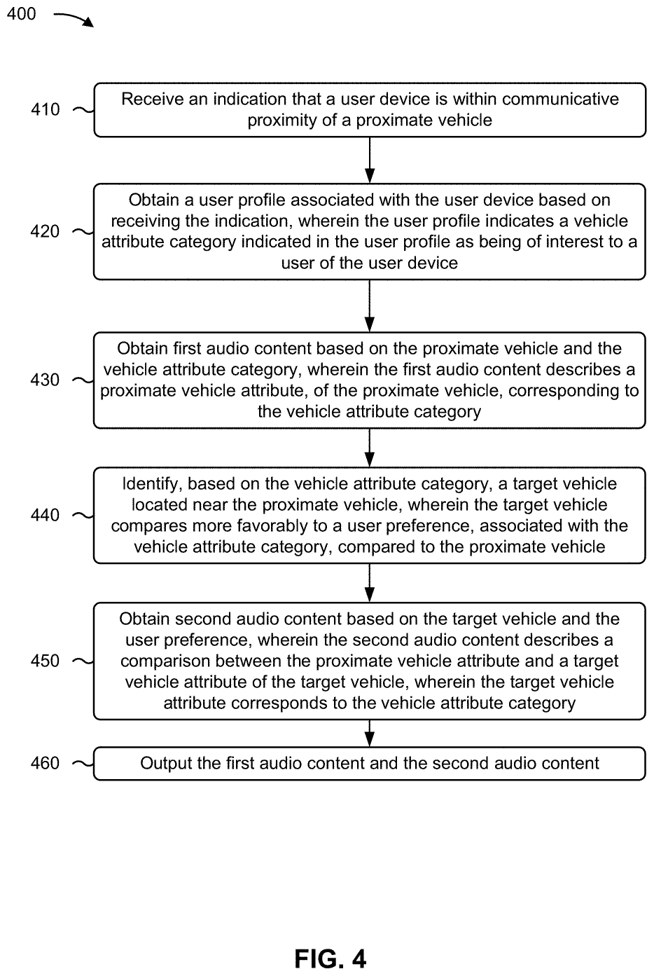

FIG. 4 is a flowchart of an example process 400 associated with proximity-based audio content generation. In some implementations, one or more process blocks of FIG. 4 may be performed by a system or device (e.g., audio system 205, audio generation device 210, and/or user device 230). In some implementations, one or more process blocks of FIG. 4 may be performed by another device or a group of devices separate from or including the system, such as audio output device 215, proximity detection device 225, client device 235, server device 240, profile storage device 245, and/or inventory storage device 250. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving an indication that a user device is within communicative proximity of a proximate vehicle (block 410). As further shown in FIG. 4, process 400 may include obtaining a user profile associated with the user device based on receiving the indication that the user device is within communicative proximity of the proximate vehicle (block 420). In some implementations, the user profile indicates a vehicle attribute category indicated in the user profile as being of interest to a user of the user device. As further shown in FIG. 4, process 400 may include obtaining first audio content based on the proximate vehicle and the vehicle attribute category (block 430). In some implementations, the first audio content describes a proximate vehicle attribute, of the proximate vehicle, corresponding to the vehicle attribute category. As further shown in FIG. 4, process 400 may include identifying, based on the vehicle attribute category, a target vehicle located near the proximate vehicle, wherein the target vehicle compares more favorably to a user preference, associated with the vehicle attribute category, compared to the proximate vehicle (block 440). As further shown in FIG. 4, process 400 may include obtaining second audio content based on the target vehicle and the user preference (block 450). In some implementations, the second audio content describes a comparison between the proximate vehicle attribute and a target vehicle attribute of the target vehicle. In some implementations, the target vehicle attribute corresponds to the vehicle attribute category. As further shown in FIG. 4, process 400 may include outputting the first audio content and the second audio content (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Accordingly, the scope of the invention should be determined not by the embodiments illustrated, but by the appended claims and their equivalents.

What is claimed is:

1. A system for generating audio content, the system comprising:
one or more memories; and
one or more processors, communicatively coupled to the one or more memories, configured to:
receive an indication that a user device is within a threshold proximity of a first vehicle;
obtain a user profile, associated with the user device and to be used to generate the audio content, based on receiving the indication that the user device is within the threshold proximity of the first vehicle, wherein the user profile indicates:
a second vehicle associated with a user of the user device, and
one or more vehicle attribute categories indicated in the user profile as being of interest to the user;
identify or generate first audio content based on the first vehicle and the one or more vehicle attribute categories, wherein the first audio content describes one or more first attributes of the first vehicle corresponding to the one or more vehicle attribute categories;
generate second audio content based on the second vehicle and the one or more vehicle attribute categories, wherein the second audio content describes a comparison between the one or more first attributes of the first vehicle and one or more second attributes of the second vehicle corresponding to the one or more vehicle attribute categories; and
output the first audio content and the second audio content.

2. The system of claim 1, wherein the one or more processors are further configured to:
receive an indication that the user device is within a threshold proximity of the second vehicle;
determine the one or more vehicle attribute categories based on an interaction of a user, of the user device, with the user device or with the second vehicle; and
update the user profile with information that indicates the second vehicle and the one or more vehicle attribute categories.

3. The system of claim 1, wherein the one or more processors are further configured to:
receive information that indicates the second vehicle and the one or more vehicle attribute categories based on a browsing history associated with a user interaction, of the user, with a web browser or an application; and
populate the user profile with the information that indicates the second vehicle and the one or more vehicle attribute categories.

4. The system of claim 1, wherein the one or more processors are further configured to:
identify, based on the one or more vehicle attribute categories, a third vehicle located near the first vehicle, wherein the third vehicle compares more favorably to a user preference, associated with a vehicle attribute category of the one or more vehicle attribute categories, compared to the first vehicle;
generate third audio content based on the third vehicle and the user preference, wherein the third audio content describes a comparison between an attribute of the first vehicle in the vehicle attribute category and an attribute of the third vehicle in the vehicle attribute category; and
output the third audio content.

5. The system of claim 4, wherein the one or more processors are further configured to:
determine a location of the third vehicle relative to a location of the first vehicle;
generate fourth audio content based on the third vehicle and the location of the third vehicle relative to the location of the first vehicle, wherein the fourth audio content describes the location of the third vehicle relative to the location of the first vehicle; and
output the fourth audio content.

6. The system of claim 4, wherein the one or more processors are further configured to:
determine a location of the third vehicle relative to a location of the first vehicle; and
transmit, to the user device, navigation information that includes at least one of a map or navigation instructions, wherein the navigation information identifies the location of the third vehicle.

7. The system of claim 1, wherein the one or more processors, when identifying or generating the first audio content, are configured to:
identify the first audio content from a plurality of audio segments stored in a data structure and associated with the first vehicle, wherein the first audio content includes one or more audio segments, of the plurality of audio segments, corresponding to the one or more vehicle attribute categories.

8. The system of claim 1, wherein the one or more processors, when identifying or generating the first audio content, are configured to:
generate the first audio content based on one or more text descriptions stored in a data structure and associated with the first vehicle, wherein the first audio content includes:
static content,
first dynamic content based on a first text description, of the one or more text descriptions, that identifies the first vehicle, and
second dynamic content based on a second text description, of the one or more text descriptions, that describes a first attribute, of the one or more first attributes of the vehicle,
wherein the first dynamic content and the second dynamic content are interspersed with the static content in the first audio content.

9. The system of claim 1, wherein the one or more processors, when receiving the indication that the user device is within the threshold proximity of the first vehicle, are configured to receive a request for audio data, wherein the request includes a user identifier, associated with the user, and information that identifies the first vehicle; and
wherein the one or more processors, when obtaining the user profile, are configured to obtain the user profile based on the user identifier.

10. A method for generating audio content, comprising:
receiving, by a system, an indication that a user device is within communicative proximity of a proximate vehicle;
obtaining, by the system, a user profile associated with the user device based on receiving the indication that the user device is within communicative proximity of the proximate vehicle, wherein the user profile indicates a vehicle attribute category indicated in the user profile as being of interest to a user of the user device;
obtaining, by the system, first audio content based on the proximate vehicle and the vehicle attribute category, wherein the first audio content describes a proximate vehicle attribute, of the proximate vehicle, corresponding to the vehicle attribute category;
identifying, by the system and based on the vehicle attribute category, a target vehicle located near the proximate vehicle, wherein the target vehicle compares more favorably to a user preference, associated with the vehicle attribute category, compared to the proximate vehicle;
obtaining, by the system, second audio content based on the target vehicle and the user preference, wherein the second audio content describes a comparison between the proximate vehicle attribute and a target vehicle attribute of the target vehicle, wherein the target vehicle attribute corresponds to the vehicle attribute category; and
outputting, by the system, the first audio content and the second audio content.

11. The method of claim 10Error! Reference source not found., further comprising:
determining a target vehicle location of the target vehicle;
obtaining third audio content based on the target vehicle location, wherein the third audio content describes the location of the target vehicle; and
outputting the third audio content.

12. The method of claim 10, further comprising:
determining a target vehicle location of the target vehicle; and
providing, for display via the user device, navigation information that includes one or more instructions for navigating to the target vehicle location.

13. The method of claim 10, wherein the proximate vehicle attribute is a first proximate vehicle attribute, wherein the vehicle attribute category is a first vehicle attribute category, and wherein obtaining the first audio content comprises:
obtaining a first audio segment that describes the first proximate vehicle attribute;
obtaining a second audio segment that describes a second proximate vehicle attribute, of the proximate vehicle, corresponding to a second vehicle attribute category indicated in the user profile as being of interest to the user;
determining a sequence in which the first audio segment and the second audio segment are to be output in the first audio content, wherein the sequence is based on an indication, in the user profile, of a relative importance of the first vehicle attribute category and the second vehicle attribute category; and
wherein outputting the first audio content comprises outputting the first audio content such that the first audio segment and the second audio segment are output in the determined sequence.

14. The method of claim 10, further comprising causing modification of an importance of one or more vehicle attribute categories included in the user profile based on an indication of detected movement of the user device in connection with a segment of the first audio content or the second audio content that is being output.

15. The method of claim 10, wherein the system is the user device.

16. The method of claim 10, wherein the indication that the user device is within communicative proximity of the proximate vehicle includes a user identifier, associated with the user, and information that identifies the proximate vehicle; and
wherein the user profile is obtained based on the user identifier.

17. A non-transitory computer-readable medium storing a set of instructions, the set of instructions comprising:
one or more instructions that, when executed by one or more processors of a device, cause the device to:
detect that the device is within proximity of a first vehicle;
transmit, based on detecting that the device is within proximity of the first vehicle, audio generation information that includes a user identifier, associated with a user of the device, and information that identifies the first vehicle;
receive, based on transmitting the audio generation information, first audio content based on the first vehicle and one or more vehicle attribute categories associated with the user identifier, wherein the first audio content describes one or more first attributes of the first vehicle corresponding to the one or more vehicle attribute categories;
receive, based on transmitting the audio generation information, second audio content based on a second vehicle and the one or more vehicle attribute categories, wherein the second audio content describes a comparison between the one or more first attributes and one or more second attributes of the second vehicle corresponding to the one or more vehicle attribute categories; and
output the first audio content and the second audio content.

18. The non-transitory computer-readable medium of claim 17, wherein the one or more instructions, when executed by the one or more processors, further cause the device to:
determine, based on detecting that the device is within proximity of the first vehicle, at least one of the second vehicle or the one or more vehicle attribute categories; and
wherein the audio generation information further includes information that identifies at least one of the second vehicle or the one or more vehicle attribute categories.

19. The non-transitory computer-readable medium of claim 17, wherein the second vehicle is one of:
a vehicle identified in a data structure associated with the user identifier, or
a vehicle that is located near the first vehicle.

20. The non-transitory computer-readable medium of claim 17, wherein the one or more instructions, when executed by the one or more processors, further cause the device to:
receive, based on transmitting the audio generation information, third audio content based on a location of the second vehicle, wherein the third audio content describes the location of the second vehicle; and
outputting the third audio content.
